(19) United States
(12) Patent Application Publication
(10) Pub. No.: US 2007/0268504 A1
(43) Pub. Date: Nov. 22, 2007

(54) ENHANCED IMAGING SPOOLER

(75) Inventors: Joel Jarrett Safer, Baton Rouge, LA (US); Daniel D. Sauer, Baton Rouge, LA (US); P. Scott Bertrand, Baton Rouge, LA (US); Andrew P. McCracken, Baton Rouge, LA (US)

Correspondence Address: NEIL J. COIG, 2355 DRUSILLA LANE, BATON ROUGE, LA, 70809, US

(73) Assignee: PROEXECUTE, LLC

(21) Appl. No.: 11/383,732

(22) Filed: May 16, 2006

(51) Int. Cl. G06F 3/12

(52) U.S. Cl. 358/1.13

(57) ABSTRACT

An enhanced imaging spooler, providing a utility capable of imaging any number of files, in any number of formats (with or without the native program present), across any number of imaging devices with minimal user involvement and time expense.

### BACKGROUND OF THE INVENTION

The present invention relates to a computer program used to efficiently route and manage imaging and/or printing tasks.

In the traditional mode of imaging computer files, (a term which comprises printing to physical media such as paper, or generating a computer file or other “image” of a computer file) several steps must be undertaken in order to effect the printed image. First, a user must ensure that he has the requisite software needed to read the file format that is sought to be opened, e.g., if a Microsoft Word® file is present, a user must either have Microsoft Word® or another program capable of viewing the file, such as AntiWord or Word Viewer 2003. Second, the file must be opened in order to view the content of the file. Third, once the file is opened, the user must issue a print command. Once this command is issued, usually another dialog box is presented to the user whereupon a logical determination must be made on the part of the user as to which imaging device is desired as the destination (such as printer, plotter, file generator or the like), what size and type of paper is to be used, which orientation is desired, which resolution is needed, whether to image in color or grayscale and so forth. Finally, the print (or image) command is issued, and the job is dispatched to the selected imaging device.

Obvious downsides to this current mode of imaging exist. Though complicated and cumbersome, taking these steps to image a single file from time to time is generally accepted as tolerable, and not particularly onerous. However, when a multitude of files is desired to be imaged, the threshold for patience with this complicated process becomes much lower, since the time required and, by extension, cost increase exponentially.

Further, it is often a problem that when imaging a series of files, a user may not have the software package needed to open each file. This is especially prevalent in the fields of construction and engineering, where hundreds of files in myriad formats are presented to companies in batches, which must then be imaged for review or submission. Similarly, in the context of legal proceedings, a multitude of files received in electronic discovery can pose a serious obstacle to expediency when imaging and review of the files en masse are needed. Actually imaging these files, then, can take hours or days, and occupy one or more people to perform the tasks outlined above.

Further still, it is often difficult to keep order among a large amount of files, to keep track of changes which may occur in a given batch of documents, or the many other difficulties which arise from attempting to efficiently and timely process and handle such a large amount of documents over a span of time.

All of these aspects of the current state of the art lead to an increased need for an innovative imaging spooler which can handle multiple files, multiple formats and multiple imaging devices, all of which the present invention addresses.

The present invention of a streamlined imaging spooler is thus a much-improved method by which a user can receive any number of files in all manner of formats and, with only a few clicks of a mouse or a few keystrokes, be able to image all the files desired across any number of imaging devices in the most efficient and expedient way possible based on setup parameters and the files' characteristics.

### OBJECTS OF THE INVENTION

One object of the invention is to provide an improved imaging spooler.

Another object of this invention is to provide an imaging spooler capable of reading multiple file formats with or without the presence of the native program.

Yet another object of this invention is to provide software capable of balancing imaging jobs among multiple imaging devices.

Still another object of this invention is to provide an imaging spooler capable of imaging any number of files.

Still another object of this invention is to provide an imaging spooler that reduces complexity and time involvement on the part of the user when imaging files.

Still another object of this invention is to provide an imaging spooler that can image altered or added files from a batch without imaging the entire batch of files repeatedly.

Other objects and advantages of this invention shall become apparent from the ensuing descriptions of the invention.

### SUMMARY OF THE INVENTION

According to the present invention, an improved imaging spooler is disclosed, providing a utility capable of imaging any number of files, in any number of formats, across any number of imaging devices. The invention is able to read multiple files at a time, and is further able to read the files regardless of whether the native program in which the files were created is present or not on the computer managing the imaging tasks. The utility thus enables a vast reduction in user involvement and time required to process imaging tasks by reducing the number of tasks required of a user, as well as intelligently assigning imaging jobs to printers and/or other imaging devices based on load considerations, characteristics of the files being imaged and the characteristics of the imaging device or devices on which imaging is being performed.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a flow chart illustrating the overall concept of the invention.

FIG. 2 is a flow chart illustrating the setup process of the invention.

FIG. 3 is a flow chart illustrating the workflow process of the invention.

FIG. 4 is a flow chart illustrating the logic used in choosing trays for the invention.

FIG. 5 is a flow chart illustrating how trays are assigned to documents.

FIG. 6 is a flow chart illustrating how the software balances the jobs among imaging devices.

FIG. 7 is a flow chart illustrating how the software monitors jobs as they are being dispatched.

### DETAILED DESCRIPTION OF EXEMPLARY EMBODIMENTS

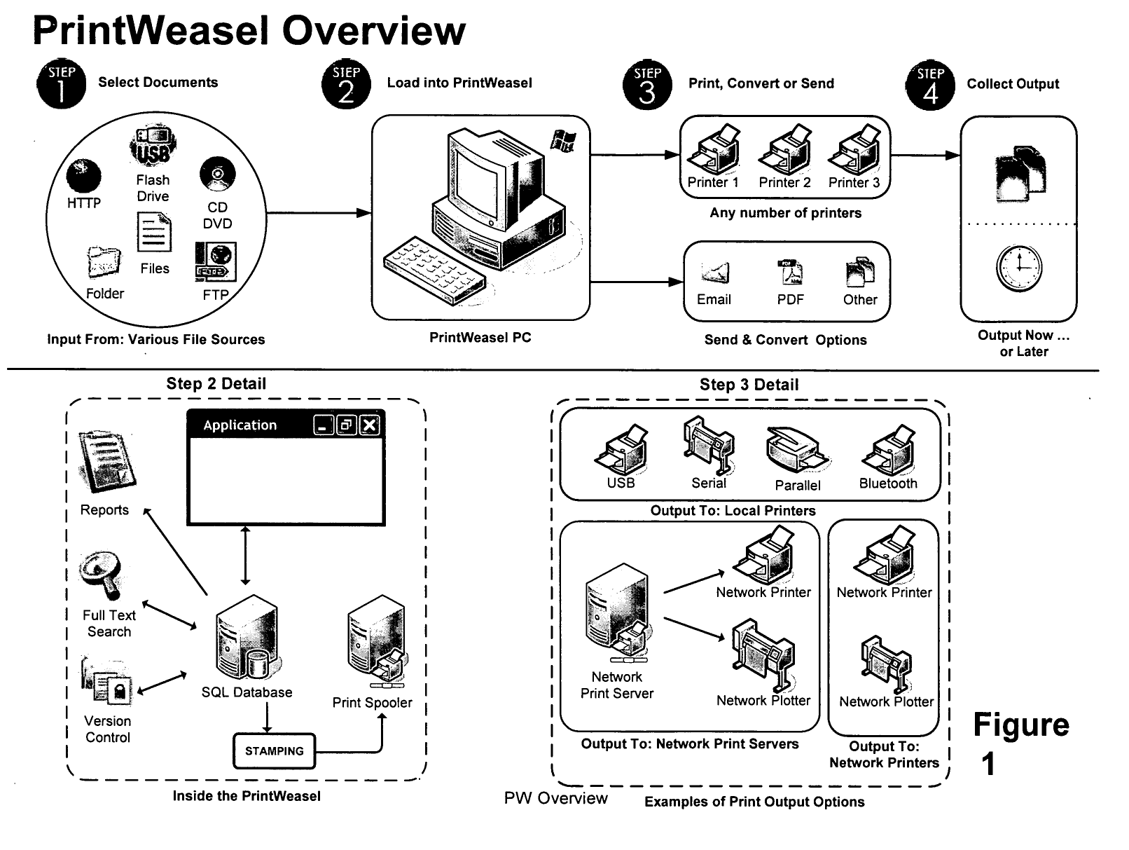

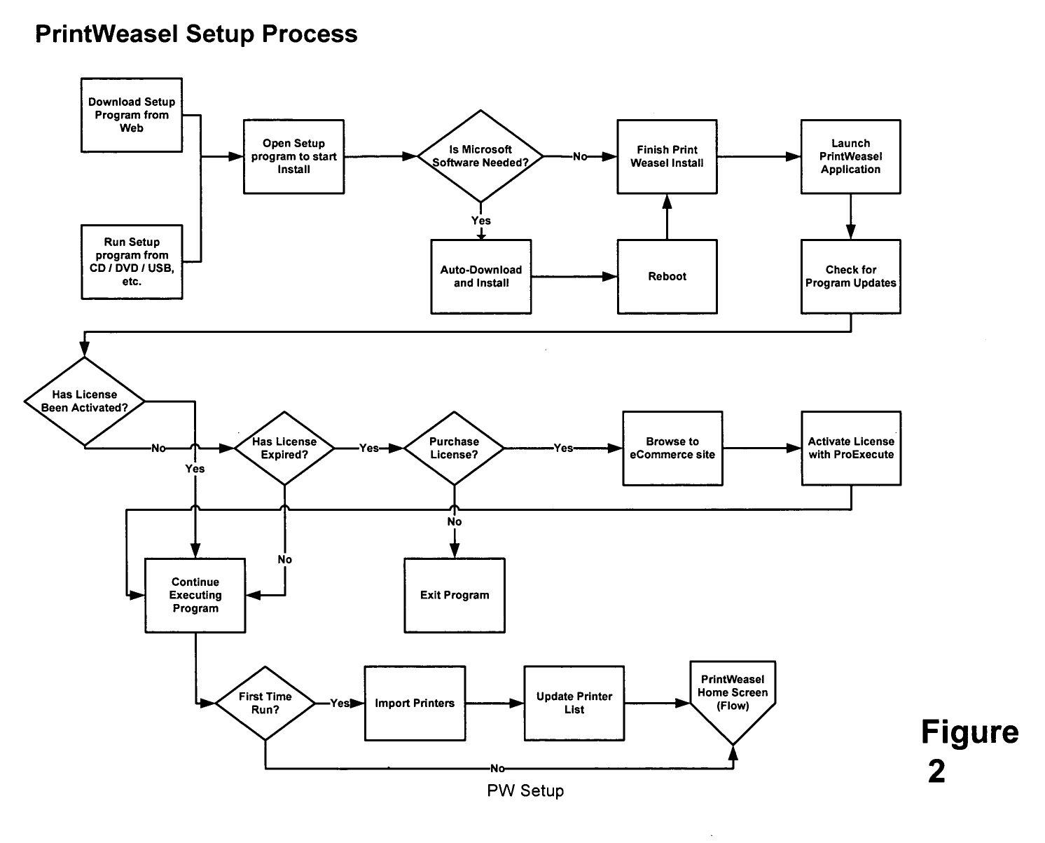

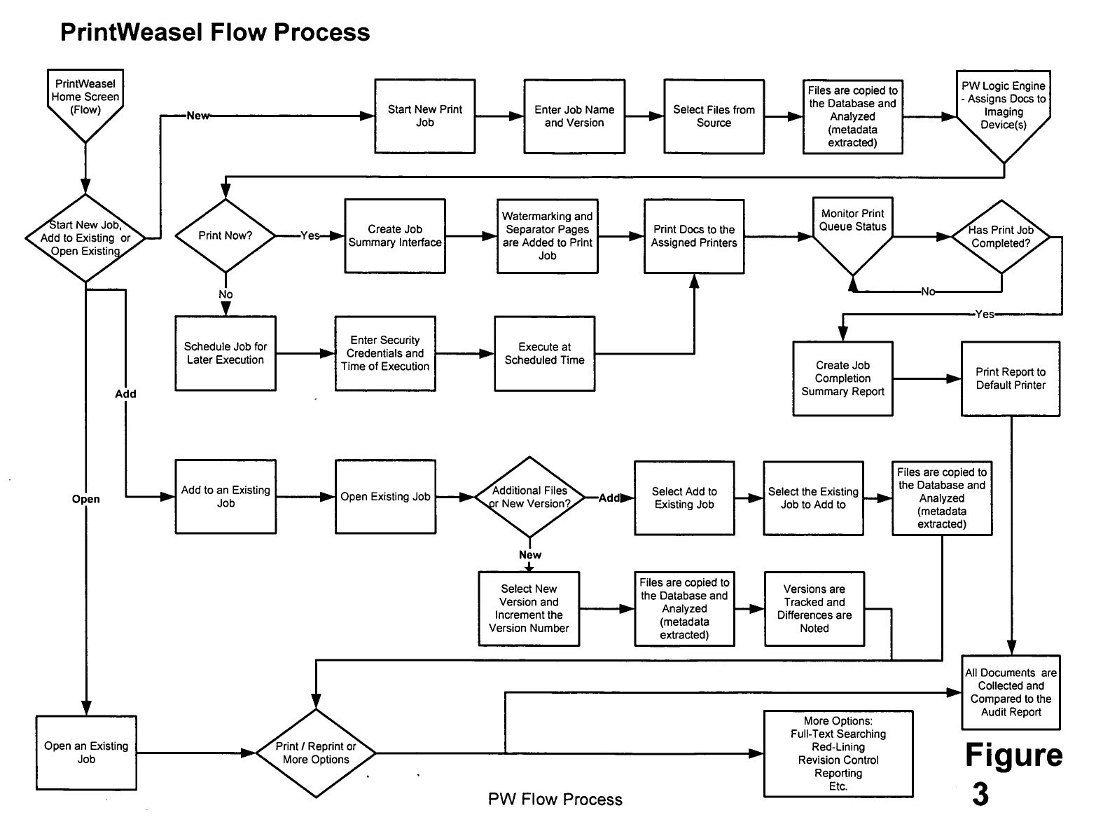

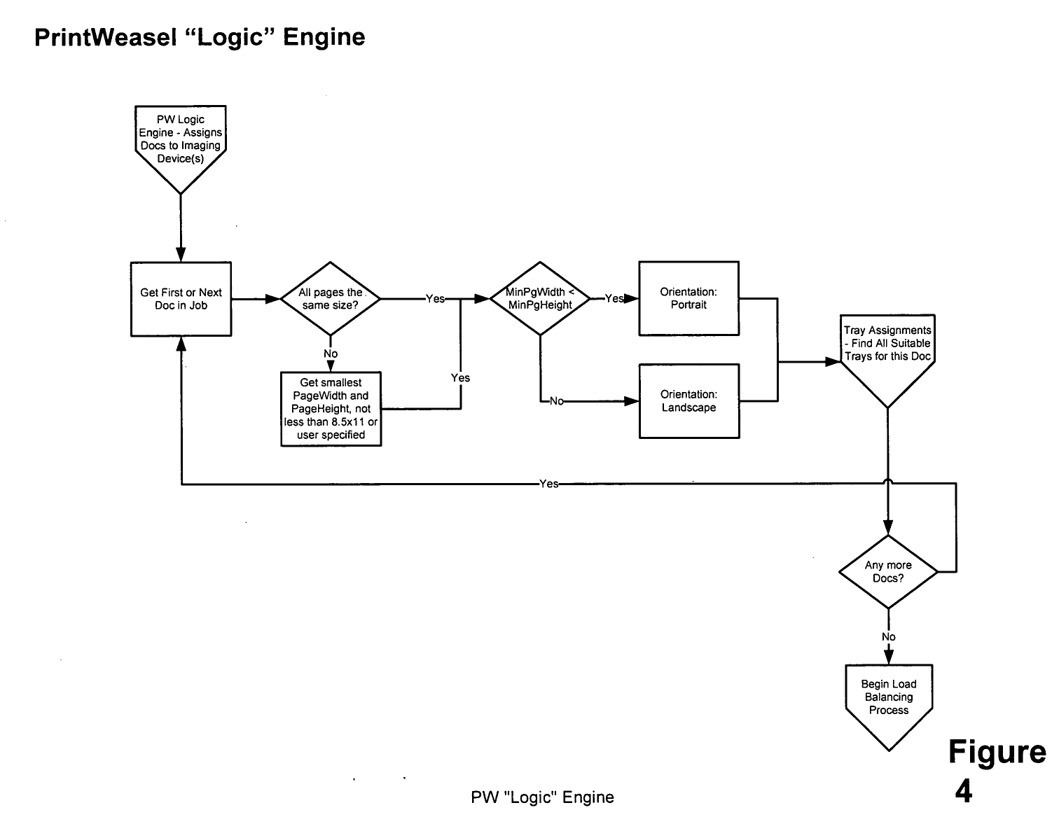

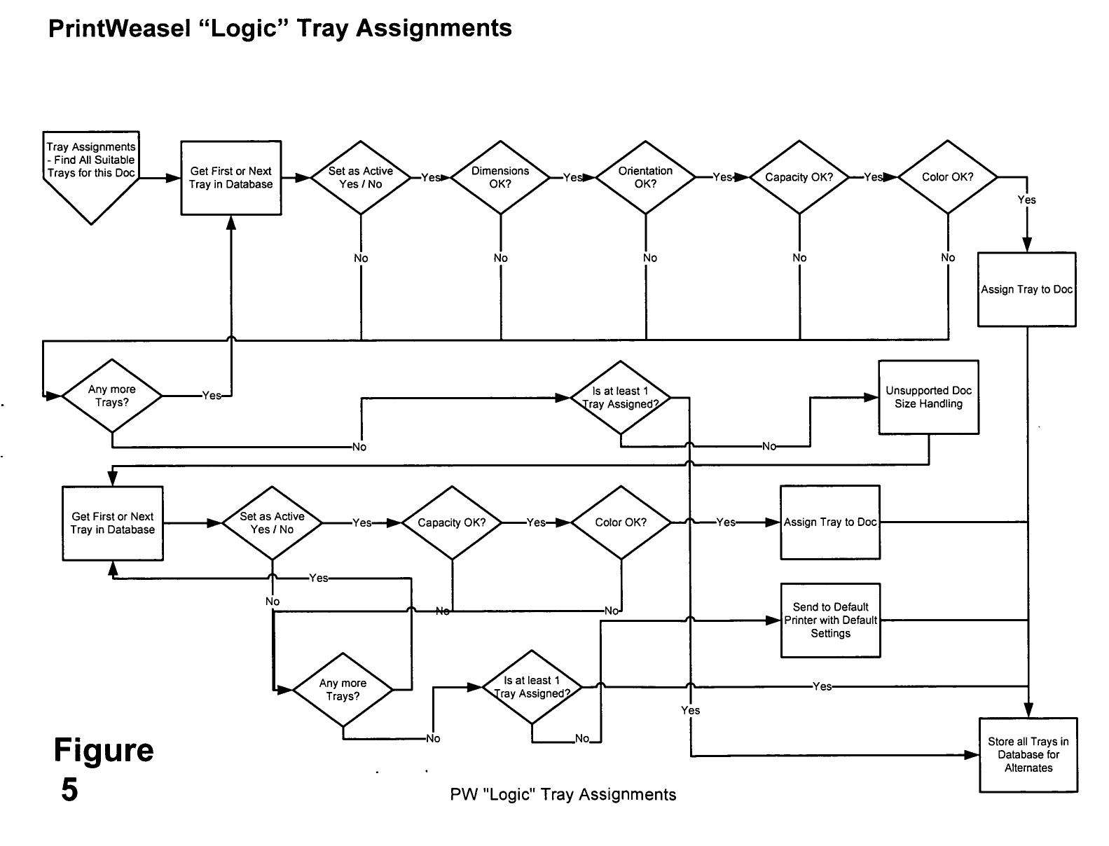

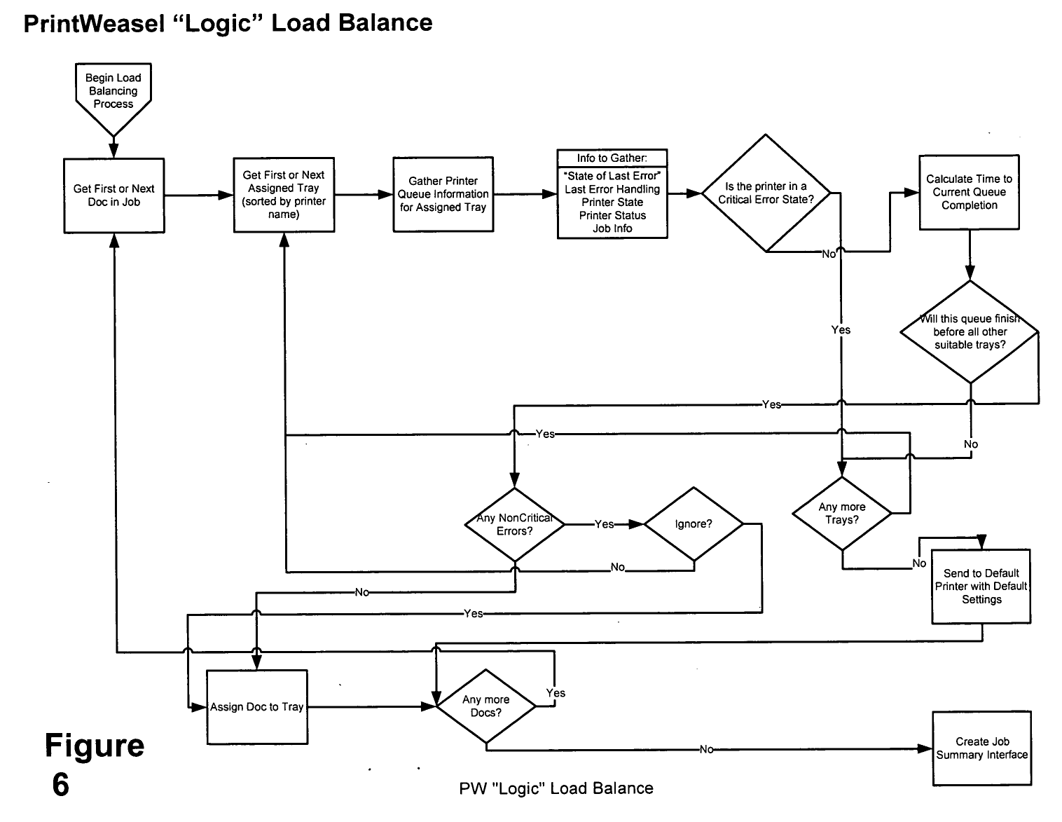

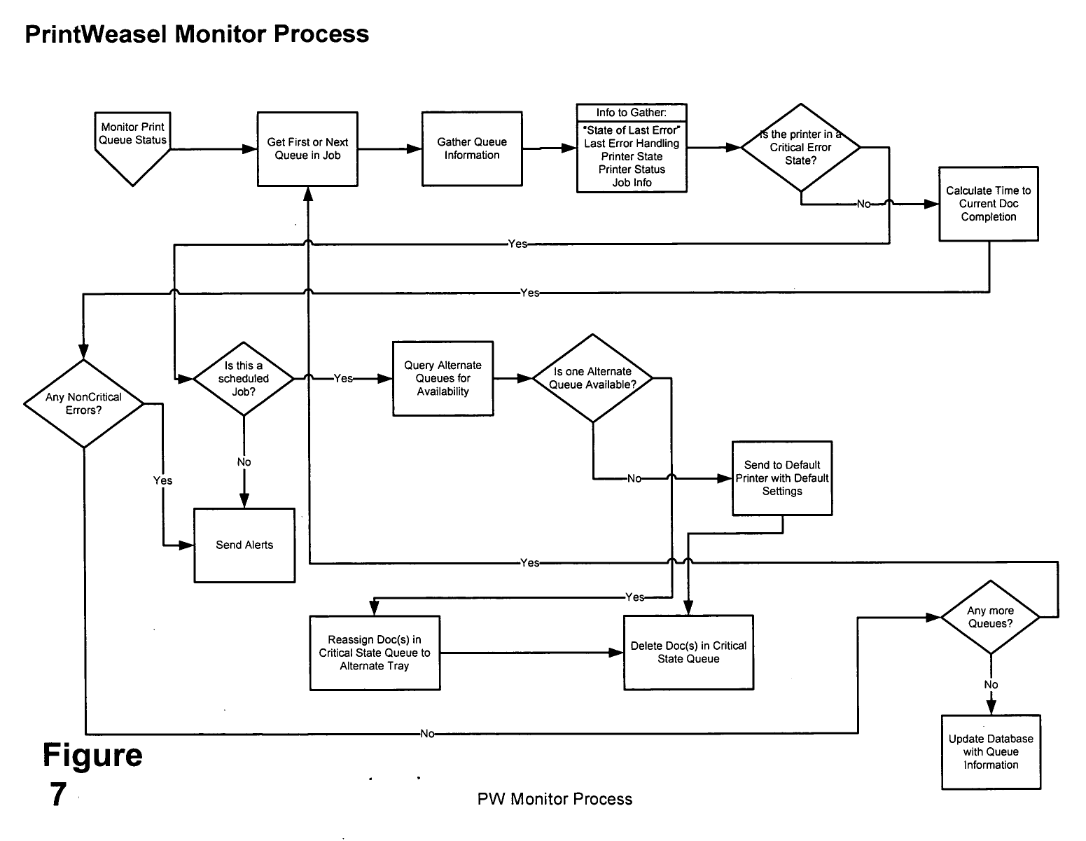

Without any intent to limit the scope of this invention, reference is made to the figures in describing the various embodiments of the invention. FIGS. 1-7 show various aspects of exemplary embodiments of the present invention.

The present invention relates to a method, software program and/or apparatus for imaging computer files. It is needed in the current state of the art to have a utility capable of imaging computer files in an optimized fashion, since, as explained above, imaging files, particularly multiple files, can be an arduous and time consuming task. The problem solved by the present invention, then, is the present inability to image any number of files, across any number of imaging devices, in any format in a minimal amount of time. Using the present invention, a user can expend a fraction of the time that was formerly spent performing this task with only a few steps, which can be carried out by even the most novice of computer users.

The present invention addresses many of the factors which have heretofore prevented the quick and efficient imaging of multiple files in varying formats among imaging devices. One of the most difficult aspects is simply the act of opening files created on many different other computers, which may be running different operating systems, different programs or different software versions to generate data files. The result of these variations is an inherent incompatibility of the files from different systems being exchanged with other users. The user seeking to image may not have the software used by the files' creator, nor the correct operating system to open these files, which results in an absolute barrier to a user's ability to image these files.

The present invention addresses this issue by incorporating the ability to read multiple file formats even when the native program is not present, thus obviating this problem. This feature is enabled by having translation code contained in the software that is able to read these various file formats. These “translators” are segments of code that are able to recognize proprietary and other file formats which would otherwise be unrecognizable by a computer without the corresponding creation software. Once recognized, the code, and thus software, are able to interpret the files, making them viewable by the user and able to be formatted for transmission to an imaging device.

These translators are available for different file formats in different ways. Some software authors make publicly available the file translators to further the influence of their software by enabling a broad base of users to view the files. In this fashion, the creation software can be sold to larger entities once the file format becomes ubiquitous. An example of this would be Adobe's Acrobat Reader®, which has become a very well known and used file format. Other translators may be licensed, or possibly even reverse-engineered in order to open file formats that may no longer be supported, or which have very limited release, such as Micro Station. Still another method of incorporating the ability to read file is by the use of a viewer or other third-party component which acts as a translator, such as Rasterex or Stellent as part of the software. Therefore, it can be seen that these and/or other types of translators are incorporated into the invention, thus enabling it to read a great variety of files without any further software being present on the computer.

By having code contained therein for many different proprietary formats, such as Microsoft Word®, AutoCAD®, WordPerfect®, Excel® and so forth, the present invention can thus read multiple file formats from many different software packages and platforms. This enables the user to read files using the software that would otherwise not be possible unless each and every one of these proprietary programs were loaded on his machine. This clearly saves the user from having the storage restrictions of accumulating multiple software packages on his computer, as well as eliminating the need for the cost for these proprietary packages, several of which cost thousands of dollars.

Another major aspect of imaging batches of files is the time required to simply open each individual file, load the print dialog, and select the imaging device destination, orientation, etc. While for a file or two this is not a major undertaking, for many files at once, this process can take hours or days—even weeks—to perform. Particularly in the context of construction, engineering or legal discovery, thousands of files may need to be imaged at a time, perhaps requiring a staff of people just to image documents, all of which results in time and cost expended on administrative tasks rather than the business of reviewing the actual files. To address this, the present invention is able to image files by location, such as directory, disk or IP (Internet Protocol) address, locating the files in one step and being able to dispatch the jobs with only a few commands or user inputs.

Yet another challenge faced by users when imaging documents deciding which imaging device, which tray and which page orientation, color depth and so forth to choose for each document. Again, deciding which imaging device or features a user requires on one or two files may not be extraordinarily difficult, but if a user is required to make this determination for several hundred or thousand files, the process becomes much more difficult and time consuming. As such, the present invention addresses this issue with two principal features: first, by determining the characteristics of each available imaging device, such as ability to print color, the number and type of print trays present, the ability to print varying paper sizes, etc.; and second, by determining each file's characteristics, e.g., whether it is in a particular orientation such as portrait or landscape, the paper size, whether there is color present in the document or not, and so on, to determine what the documents' salient features are. Then, armed with these two bits of information, the invention can be configured to make a logical determination as to which imaging device is best suited to handle each file based on the known characteristics of the imaging devices available to a user and the known characteristics of the files being imaged, and subsequently dispatch the job to the best-suited imaging device. As a result, the program is able to intelligently dispatch documents that are in color to color printers, tabloid sheets to tabloid capable printers, landscape jobs to a printer's landscape tray and so on.

The invention is also able to logically balance these jobs across multiple imaging devices to maximize efficiency and reduce imaging time by keeping imaging jobs apportioned across many imaging devices. This reduces the imaging time as well, by “load balancing” across all available imaging devices, instead of sending all documents to one imaging device, or requiring the task of apportioning the documents among imaging devices to a person. For example, when a printer capable of imaging sixty pages per minute is paired with one capable of imaging five pages per minute, the invention can send more work to the printer capable of printing faster, in this case, the sixty page per minute printer, thus logically balancing the print jobs to keep both printers busy and efficiently utilized.

The invention can also incorporate a host of other convenience features, such as an internal file viewer, the ability to watermark files as they are imaged, generating reports of files imaged, their status, characteristics and so on, porting (auditing), content indexing (enabling full-text searching), database storage benefits, reimaging services, the imaging of separator pages, file checks, red-lining of documents and more.

In operation, then, the method is common among all variants of the invention, and consists of setup steps and operating steps. The software version of the invention will be discussed here as an exemplary embodiment of the invention, however, the same method can be applied to a hardware printing appliance or other variant of an imaging spooler. The software is configured to reduce the number of steps and thus, involvement that an end user has in operating the software. To that end, only a few setup steps need to be taken in the software, and subsequently, even fewer steps will be required to operate the software and actually image files utilizing the invention, since setup need only be performed once.

In the initial setup, the user will be able to have the software scan his computer's registry for imaging resources, such as local printers, network printers, IP printers, PDF generators and the like. Once all of the imaging devices are found, either by manual selection or automatic discovery, the software permits the user to configure the characteristics of the imaging device, such as the number of trays, the size and type of paper located in each tray, whether the imaging device is color or not, and so on. The program can attempt to make these judgments on its own; however, the user may make adjustments (such as turning off a tray) or other changes to ensure that the settings are correct, or at least, that they reflect the user's intent with regard to imaging device use, since some imaging devices may not be desired to be utilized in the imaging task. The software will store this imaging device information in non-volatile memory for use in the future. Once this step is carried out, the software is ready to be used for printing or imaging.

The user will start by loading a disc, locating a directory of files or otherwise identifying a supply of files in need of imaging. Using a file navigation box, like those found in many software programs, the user will specify which directory (or directories) contains the files desired to be imaged. The software will further be able to read within archives, compressed files and other file groups transparently, should such files be selected for imaging.

The software will then read each file, whereupon it can store the files' information in memory for immediate use or store it in non-volatile memory for future use as well. An example of such non-volatile storage would be a database, wherein the file and its characteristics can be catalogued with some level of permanence. The characteristics stored will include things such as the file type, file size, file date, whether the file contains color, page orientation and the like. Overlay information, watermarking, or any other desired or pertinent data can also be stored in this database.

Once the software reads the files and has analyzed and stored the files' characteristics, the software will make a logical determination of the best imaging destination for each file based on a logical determination or optimal match between the files and the available imaging devices. This optimal match can be made based on a variety of factors, such as imaging device type, current load on an imaging device, print speed of a device, whether an imaging device is capable of color printing, etc. These factors can be prioritized, either in the software, or by a user, to ensure an ideal match between the imaging device and the file being imaged. The optimal match will typically be drawn from the imaging devices and/or trays which are capable of handling the characteristics of a particular file (such as color, size and the like) and then a selection is made of the trays having the proper capabilities by calculating the least amount of time until a job is complete, or the first-available tray. Of course, one or more optimal matches may be made, or, a match can not be found, which would require the file be imaged to the default imaging device.

The optimal match between file and imaging device can be preconfigured by the software author, or provisions can be made in the software to permit varying levels of user intervention to change some or all parameters to aid in determining the optimal match. Essentially, different priorities can be given to different characteristics of both the file(s) and imaging device(s) to aid in determining the optimal match. For example, an absolute priority can be given to the capabilities of an imaging device, whereby an imaging device that is incapable of handling a job will not ever be assigned such job. Color jobs, in another instance, would typically not be assigned to a black and white printer, but those with low color depth may be permitted to be imaged on black and white imaging devices, regardless. Other priorities can be given to aspects such as paper size, such that a printer with a legal tray will be assigned jobs containing legal sized-images over a printer without a legal tray, in order to avoid unnecessary resizing of images. The number of jobs assigned to an imaging device currently can also be factored in. For example, a printer may be defined by the software to be capable of a certain number of pages per minute, and thus the number of pages apportioned for each imaging device would be calculated to make the jobs finish as quickly as possible based on the available hardware. Similarly, the software can be configured to determine an imaging device's current status and either read or calculate the time to image certain jobs to assist in load balancing.

The software can also contain a provision to permit a simple forced preference to be indicated so that a user could select the imaging device that he would like jobs to go to unless there are jobs that such imaging device could not handle, or all jobs could simply be forced to the same imaging device, if desired. The essential aspect here is that the priority and resultant assignments of print jobs to imaging devices is fully customizable, if desired, or can be fully automated upon configuration.

Finally, the files will be transmitted to the imaging device assigned by the software, and subsequently generated for the user to retrieve from each of the utilized imaging devices. The software can be configured to monitor the progress of these jobs such that jobs can be re-allocated in the event of an error or backlog, or if paper or ink is depleted. The end result is any number of files in any format being quickly imaged with as few as two or three steps and very little user interaction.

In an exemplary embodiment, the steps will begin with setting any job-specific data or initial options, such as the job name, file locations and file version number, once the software is started. The files desired to be imaged will then be selected, their information copied to a database, if applicable, and analyzed. In this analysis step, the metadata, or the file's characteristics, will be extracted from each file and added to the database. The software will then use a logic sequence to determine where each file should be imaged.

In this logic sequence, each file is analyzed first to determine the page orientation. This is achieved by comparing the width of the page to the height. If the maximum page width is less than the minimum page width, the orientation is assigned as “portrait,” and by comparison, if the maximum width is greater than the minimum page width, the orientation is assigned as “landscape.” If all of the pages in a document are all the same size, this calculation is based on the common page size. If not, the smallest page is extracted from the file, and the logic above is applied to that page.

Using all configured destinations, or trays, an analysis is performed to determine which are suitable for a document's properties. Several logical questions must be posed, such as whether a tray is active, whether the dimensions of the tray are adequate for the document, whether the capacity, orientation, color and so forth are suited for imaging a document to the tray. This analysis is performed on each tray until an optimal match, or matches, are found. From this information, eligible destinations, or trays, can be set, and then the software progresses to the load-balancing routine.

In the load-balancing routine, the software will examine the trays that are set for a particular document to first determine if there is an error state or other information that would preclude the tray from being able to complete the imaging job. Provided there are no errors or other impediments to the tray being able to image, the time to complete the current queue is calculated and a determination is made as to whether the completion time is suitable, that is, whether the tray's queue of current jobs will finish prior to any other eligible trays. Should this completion time be satisfactory, then the document is assigned to the tray and dispatched accordingly. This step is repeated for every document sought to be imaged until all documents are dispatched. If more than one tray is eligible and available, the software can select the tray to be used by the name, date/time of last use, or other characteristics as desired by the user/software engineer.

During the course of dispatching jobs to the various imaging devices, the jobs and imaging device states are monitored to ensure that the work flow is proceeding normally. The imaging devices are polled to determine if an error state exists, and if so, the software will determine if it would be more expeditious to route the print jobs to other trays or other imaging devices, whenever possible, and remove pending jobs from an imaging device that is unable to complete a job. Throughout the course of these assignments and changes, notations are made in the database by the software in order to maintain the location and destination for the jobs delivered.

At the conclusion of the imaging jobs, a report is generated which summarizes which jobs where sent to which imaging devices, to make the assembly of the multiple documents easier and to indicate any errors that the software may have detected. This report also enables the user to compare the documents to ensure all documents have been generated and collected. These reports, as well as the previously mentioned watermarking or other insertions in changes comprise any number of annotations which the software would be able to provide to ease in the processing, identification and sorting of the imaged documents.

As an additional feature, the software is able to revisit old jobs to image revised or added documents. The contents of the database created by the software is compared to the files indicated by a user, and should it be desired, any added or changed documents can be queued for imaging in the same fashion as described above. Comparisons can also be made of using overlay comparisons or other technology to detect changes in a document (e.g., overlay comparisons can be used to detect changes in vector images, or Cyclical Redundancy Checking (CRC) comparisons may be used). Any added or changed documents are updated in the database as they are discovered in order to keep the document information current. This is useful for imaging only updated documents, without the typically attendant reprinting and/or time requirements.

Varying versions of the software can also be implemented, such as the full version described above (often dubbed a “Professional” version), or a scaled back version that eliminates some features, such as database usage and the like (often dubbed a “Light” version). Such a scaled back version would, for instance, be able to be run in environments with low resources, or in a portable context, whereby the software might be run from portable media, flash drives and the like. An “Enterprise” version may also be implemented which utilizes a central storage database, rather than individual databases on each workstation.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A method for imaging a plurality of computer files comprising:
a. storing the characteristics of a plurality of imaging devices in memory;
b. receiving input indicating a plurality of files desired to be imaged;
c. translating said files from their native format into a format viewable and imageable by a user;
d. reading said files into memory;
e. analyzing said files' characteristics;
f. storing said characteristics into memory; and
g. assigning an imaging device to each of said files based on an optimal match of the characteristics of said files to the characteristics of said imaging devices.

2. The method for imaging a plurality of computer files according to claim 1 further comprising transmitting said plurality of files to said assigned imaging device.

3. The method for imaging a plurality of computer files according to claim 1 wherein said optimal match is determined by finding the imaging device whose capabilities match said characteristics of said computer file and by determining the imaging device having the minimal amount of time remaining before said imaging device is able to image said file.

4. The method for imaging a plurality of computer files according to claim 1 further comprising the ability to generate annotations between said files.

5. The method for imaging a plurality of computer files according to claim 1 further comprising the ability to generate annotations within said files.

6. The method for imaging a plurality of computer files according to claim 1 wherein said files' characteristics are stored in a database.

7. The method for imaging a plurality of computer files according to claim 1 further comprising the step of comparing the characteristics of said files to the information stored in said memory.

8. The method for imaging a plurality of computer files according to claim 7 further comprising transmitting to said imaging devices only those files whose comparisons yield unequal results.

9. The method for imaging a plurality of computer files according to claim 1 further comprising the step of monitoring the progress of said imaging of said files, and re-assigning said optimal match should the imaging device being used no longer be available or able to image said plurality of files.

10. A method for imaging one or more computer files comprising:
a. storing the characteristics of at least one imaging device in memory;
b. receiving input indicating at least one file desired to be imaged;
c. translating said at least one file from its native format into a format viewable and imageable by a user;
d. reading said at least one file into memory;
e. analyzing said at least one file's characteristics; and
f. assigning an imaging device to each of said at least one file based on an optimal match of the characteristics of said at least one file, the characteristics of said imaging devices and the current load on said imaging device.

11. The method for imaging one or more computer files of claim 10 further comprising transmitting said at least one file to said assigned imaging device.

12. A computer program for use with a display device, said computer program product comprising a computer-usable medium having computer-readable program code embodied in said medium for performing imaging tasks having:
a. computer-readable program code for storing a set of imaging devices;
b. computer-readable program code for storing characteristics of said imaging devices;
c. computer-readable program code for receiving input from a user indicating files to be imaged;
d. computer-readable program code for translating various file formats;
e. computer-readable program code for reading said files to be imaged;
f. computer-readable program code for logically selecting to which of said imaging devices said files are to be transmitted;
g. computer-readable program code for transmitting said files to said selected imaging devices.
h. computer-readable program code for repeating the steps of performing imaging tasks until all files have been transmitted.

13. A imaging spooler comprising a device capable of performing the following steps:
a. storing the characteristics of at least one imaging device in memory;
b. receiving input indicating at least one file desired to be imaged;
c. translating said at least one file from its native format into a format viewable and imageable by a user;
d. reading said at least one file into memory;
e. analyzing said at least one file's characteristics;
f. assigning an imaging device to each of said at least one files based on an optimal match of the characteristics of said files to the characteristics of said imaging devices.

14. The imaging spooler of claim 13 further comprising the step of transmitting said at least one file to said assigned imaging device.

15. The method for imaging a plurality of computer files according to claim 13 wherein said optimal match is determined by finding the imaging device whose capabilities match said characteristics of said computer file and by determining the imaging device having the minimal amount of time remaining before said imaging device is able to image said file.
